(19) United States
(12) Patent Application Publication
(10) Pub. No.: US 2018/0329460 A1
(43) Pub. Date: Nov. 15, 2018

(54) FLEXIBLE HINGE DEVICE HAVING CAM STRUCTURE

(71) Applicant: PREXCO CO., LTD, Chungcheongnam-do (KR)

(72) Inventor: In-Sung Song, Gyeonggi-do (KR)

(21) Appl. No.: 15/527,870

(22) PCT Filed: Jul. 2, 2015
(86) PCT No.: PCT/KR2015/006829

§ 371 Date: May 18, 2017

(30) Foreign Application Priority Data
Jun. 10, 2015 (KR) 10-2015-0082057

(51) Int. Cl. G06F 1/16

(52) U.S. Cl. CPC G06F 1/1681; G06F 1/1652; G06F 1/1626

(57) ABSTRACT

A flexible hinge device having a cam structure includes: a first plate and a second plate equipped with a foldable flexible display screen on tops thereof; and a hinge unit connecting the first plate and the second plate to each other and being able to bend and unbend. The hinge unit is composed of a plurality of joint members that are connected to each other to bend or unbend, and the first plate and the second plate are respectively connected to outermost joint members of the joint members. The joint members each have: a cam portion longitudinally extending; fixed portions extending inward at both ends of the cam portion with a predetermined gap therebetween; fixing members each having a head and a pin longitudinally extending at an end of the head; and pivot portions extending outward at both ends of the fixed portions with a predetermined gap therebetween.

### CROSS-REFERENCE TO RELATED APPLICATION

This Application is a Section 371 National Stage Application of International Application No. PCT/KR2015/006829 filed Jul. 2, 2015, the contents of which is hereby incorporated by reference in its entirety.

### TECHNICAL FIELD

The present invention relates to a flexible hinge device having a cam structure and, more particularly, to a flexible hinge device having a cam structure in which an end position difference between first and second plates and a flexible display screen can be reduced only by a hinge unit without an additional variable component and joint members of the hinge unit can be bent along the same path.

### BACKGROUND ART

In general, portable terminals, such as a smartphone and a tablet PC that can access the internet by improving mobile phones, are very popular in recent years. Such devices are made possible due to development of communication technologies, semiconductors and optical technologies. These changes have affected all life environments of humans and have brought about remarkable advances in science and technology. Of these portable terminals, the tablet PC in particular has a defect that the display screen is wide and the volume thereof is large, thus it is inconvenient to carry.

As solution for this problem, a flexible display has been proposed. As a prior art relating to the flexible display substrate that is foldable/unfoldable, ┌Flexible display substrate┘ has been proposed in Korean Patent Application Publication No. 10-2010-0112383-1. The flexible display means a display that can be rolled, or curved or bent like paper, and freely designed. Further, since the substrate is flexible, the display can withstand breaking. Accordingly, a flexible display may be realized as a thin & light display by using a thin and light substrate such as plastic in some cases

The most basic type would be the flexible display that can be carried with the volume reduced by half by folding in half. Even in this foldable type, it is preferable that the flexible display cannot be bent and folded like folding paper but can be folded with smooth curvature.

As a foldable flexible display device, a “Foldable flexible display device with resist of forcement means” has been disclosed in Korean Patent No. 10-1467857.

However, the foldable flexible display device includes a variable unit, which includes a moving plate coupled to most areas of the rear sides of a first plate and a second plate through a hinge and a guide member for guiding the moving plate that moves forward and backward, in order to solve the problem of an end position difference that is generated between the first and second plates, and a flexible display screen attached to the tops of the first and second plates when a hinge portion is bent, so the first and second plates are thick and the configuration is also complicated.

### DISCLOSURE

### Technical Problem

In order to solve the problems described above, objects of the present invention are as follows.

First, an object of the present invention is to reduce an end position difference that is usually generated between first and second plates, and a flexible display screen when a hinge unit is bent, without an additional component.

Second, another object of the present invention is to reduce the thickness and manufacturing cost of a flexible hinge device by removing an additional component for reducing the end position difference.

Third, another object of the present invention is to allow a plurality of joint members of a hinge unit to be bent at the same angle by coupling the joint members through a plurality of extension members.

Objects of the present invention are not limited to those described above and other objects not stated above will be clear to those skilled in the art through the following description.

### Technical Solution

A flexible hinge device having a cam shaft according to the present invention includes: a first plate and a second plate equipped with a foldable flexible display screen on tops thereof; and a hinge unit connecting the first plate and the second plate to each other and being able to bend and unbend, in which the hinge unit is composed of a plurality of joint members that are connected to each other to bend or unbend, and the first plate and the second plate are respectively connected to outermost joint members of the joint members, and the joint members each have: a cam portion longitudinally extending; fixed portions extending inward at both ends of the cam portion with a predetermined gap therebetween; fixing members each having a head and a pin longitudinally extending at an end of the head; and pivot portions extending outward at both ends of the fixed portions with a predetermined gap therebetween.

The cam portion may have: a plurality of cam noses protruding from a top of the cam portion and arranged in series with a predetermined distance therebetween; and a plurality of cam holes formed on a bottom of the cam portion to vertically correspond to the cam noses.

The cam holes each may have: an insertion hole formed at an upper portion inside the cam hole so that a cam nose of a lower cam portion is inserted therein; a convex portion formed at a center portion inside the cam hole such that the cam nose smoothly slides over the convex portion; and a seat formed at a lower portion inside the cam hole to seat the cam nose thereon.

The cam portions each may have: a plurality of top fixing grooves formed between the cam noses; a plurality of bottom foxing grooves formed between the cam holes; and tension members connecting the top fixing grooves and the bottom fixing grooves of a cam portion adjacent to the top fixing grooves to each other.

The tension members may connect even-numbered or odd-numbered top fixing grooves and the bottom fixing grooves of a cam portion adjacent to the top fixing grooves to each other.

The tension members may be coil springs or spiral springs.

Cover plates or magnets may be attached to other top fixing grooves and bottom fixing grooves except for the top fixing grooves or the bottom fixing grooves connected by the tension members.

The heads may be coupled to front sides of the fixed portions such that the pins face the outside.

The pivot portions each may have: a pierced portion having a through-hole therein; and a stepped portion formed under the pierced portion, and a smooth oblong hole may be formed in the stepped portions.

The pins may pass through the through-holes and may be rotatably inserted in the oblong holes of stepped portions over the pierced portions.

### Advantageous Effects

According to the present invention, without an additional component, it is possible to reduce an end position difference that is usually generated between first and second plates and a flexible display screen when a hinge portion is bent.

Further, it is possible to bend a plurality of joint members of a hinge portion at the same angle by coupling the joint members through a plurality of extension members.

### DESCRIPTION OF DRAWINGS

FIGS. 1 to 4 are views showing use of an embodiment of the present invention.

FIGS. 5 to 7 are cross-sectional views of a cam portion according to an embodiment of the present invention.

FIGS. 8 to 9 are exploded perspective views of the joint members according to an embodiment of the present invention.

FIGS. 10 and 11 are views showing use of fixed portions and pivot portions according to an embodiment of the present invention.

### Best Mode

Hereinafter, preferred embodiments of the present invention will be described in detail with reference to accompanying drawings.

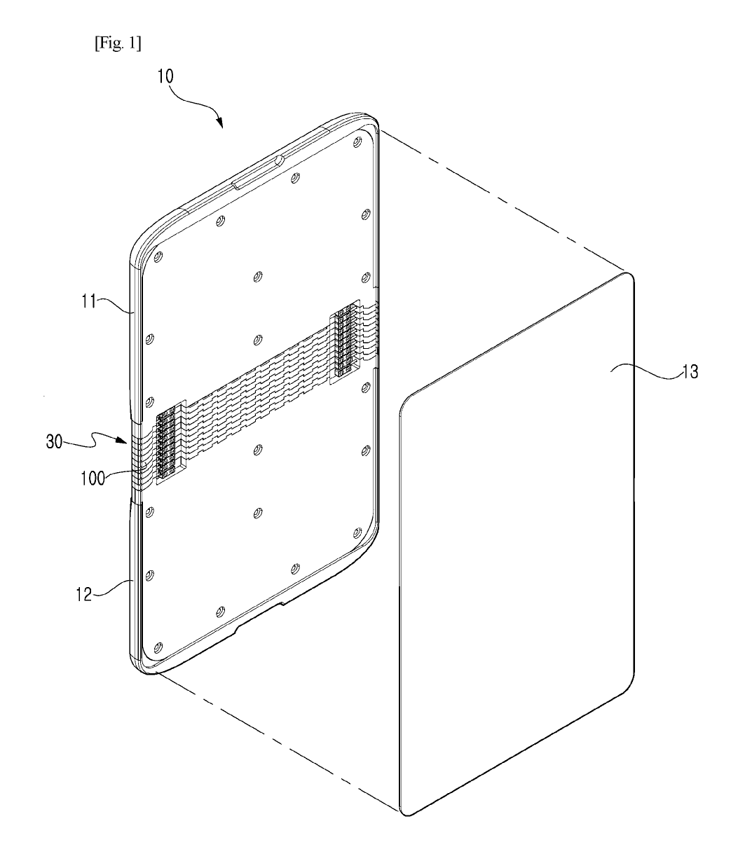

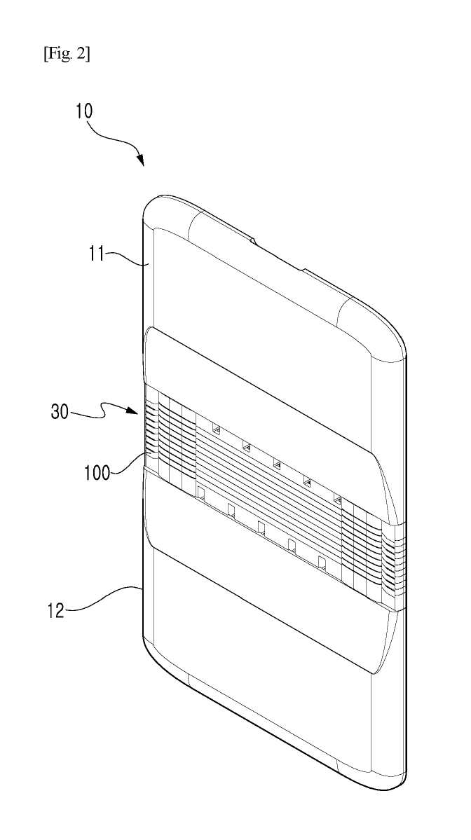

As shown in FIGS. 1 to 4,

a flexible hinge device 10 having a cam structure according to an embodiment of the present invention includes a hinge unit 30 that connects a first plate 11 and a second plate 12 equipped with a foldable flexible display screen 13 on tops thereof, and that can bend and unbend.

The hinge unit 30 includes a plurality of joint members 100 connected a link member to be able to bend and unbend, and the first plate 11 and the second plate 12 are respectively connected to the outermost joint members 100 of the joint members 100.

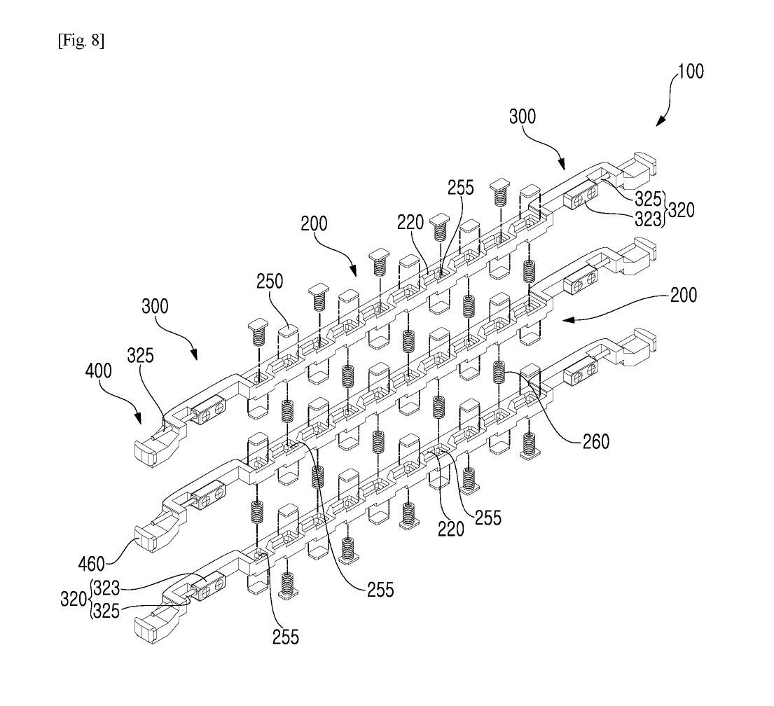

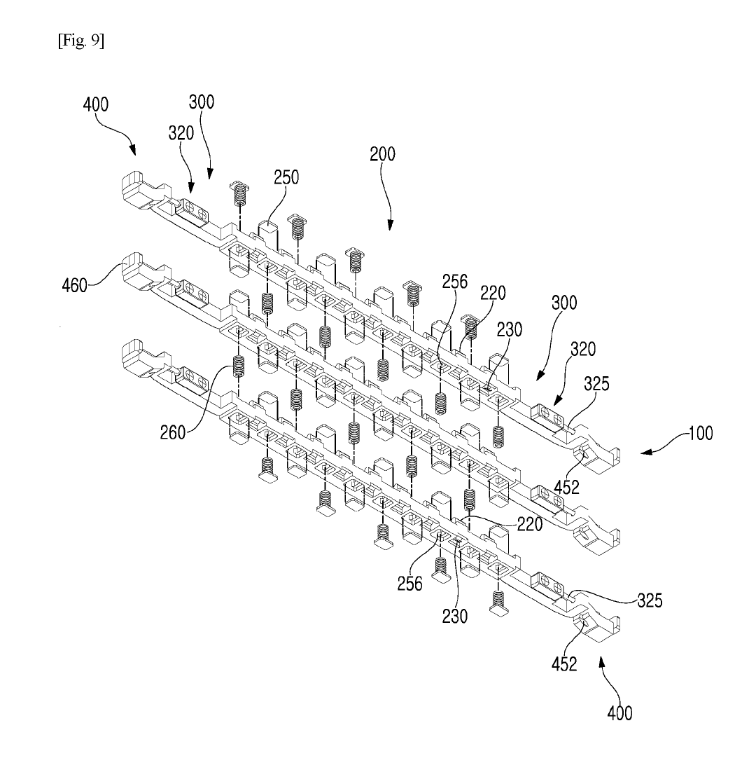

As shown in FIGS. 8 and 9,

the joint members 100 have a long bar shape and are each composed of cam portion 200, fixed portions 300, and pivot portions 400.

The cam portion 200 is positioned at the center portion of the joint member 100, longitudinally extends, and has cam noses 220 and cam holes 230 on the top and bottom, respectively.

The fixed portions 300 extend inward from both ends of the cam portion 200 with a predetermined distance therebetween. Fixing members 320 to be described below are coupled to the fixed portions 300.

The pivot portions 400 extend outward from both ends of the fixed portions 300 with a predetermined distance therebetween. Oblong holes 452 in which pins 325 (described below) of the fixing members 320 are rotatably inserted are formed at the pivot portions 400. The pivot portions 400 are the outermost portions of the hinge device 10 according to the present invention and finishing portions 460 for improving an aesthetic appearance or increasing durability of the hinge device 10 are formed at both ends of the pivot portions 400.

Tension members 260 of the components of the cam portion 200 are described with reference to FIGS. 8 and 9.

The cam noses 220 protruding from the top of the cam portion 200 are formed in series with a predetermined distance therebetween and top fixing grooves 255 are formed at the other portions on the top of the cam portion 200 except for the portions where the cam noses 220 are formed.

A plurality of cam holes 230 vertically corresponding to the cam noses 220 is formed on the bottom of the cam portion 200 and bottom fixing grooves 256 are foamed at the other portions on the bottom of the cam portion 200 except for the portions where the cam holes 230 are formed. That is, the top fixing grooves 255 vertically correspond to the bottom fixing grooves 256.

Further, the tension members 260 that are coil springs or spiral springs connect the top fixing grooves 255 and the bottom fixing grooves 256 of a cam portion 200 adjacent to the top fixing grooves 255. Locking projections (not shown) for locking the tension members 260 are formed in the top fixing grooves 255 and the bottom fixing grooves 256.

The tension members 260 connect the even-numbered top fixing grooves 255 and the even-numbered bottom fixing grooves 256 of the camp portion 200 adjacent to the top fixing grooves 255, and connect the odd-numbered top fixing grooves 255 and the even-numbered bottom fixing grooves 256 of the cam portion 200 adjacent to the top fixing grooves 255.

That is, the tension members 260 alternately connect the even-numbered top fixing grooves 255 and even-numbered bottom fixing grooves 256 to each other and the odd-numbered top fixing grooves 255 and the odd-numbered bottom fixing grooves 256 to each other in the cam portions 200 that are connected in parallel.

The reason of arranging the tension members 260 in this way is for bending the joint members 100 at the same angle through distributed tension of the tension members 260 when the hinge unit 30 is bent.

Further, the other top fixing grooves 255 or bottom fixing grooves 256 except for the top fixing grooves 255 or the bottom fixing grooves 256 that are connected by the tension members 260 are covered with cover plates 250. This is for finishing clearly the other fixing grooves 255 and 256 connected by the tension members 260.

Magnets may be attached instead of the cover plates 250. Accordingly, although it is possible to keep the hinge unit 30 horizontal only with the tension of the tension members 260, it is required to keep the hinge unit 30 horizontal with stronger force for not small mobile terminal display devices, but relatively large display devices such as a tablet PC, so in this case, magnets are attached instead of the cover plate 250.

Further, the top fixing grooves 255 or the bottom fixing grooves 256 that are covered with the cover plates 250 or magnets can also be connected by the tension members 260, but it increases the manufacturing costs and makes the manufacturing process complicated, so it would be preferable to alternately connect the even-numbered or odd-numbered top and bottom fixing grooves 255 and 256 using the tension members 260, as described above.

FIGS. 5 to 7 are cross-sectional views of the cam portion 200, and the structure and operation of the cam noses 200 and the cam holes 230 of the components of the cam portion are described with reference to FIGS. 5 to 9.

First, as described above, the cam noses 220 protruding from the top of the cam portion 200 are formed in series with a predetermined distance therebetween and cam holes 230 vertically corresponding to the cam noses 220 are formed on the bottom of the cam portion 200.

The structure of the cam holes 230 is as follows (see FIGS. 5 to 7).

Insertion holes 231 for insertion of the cam noses 220 of another cam portion 220 coupled to the bottom of a cam portion 220 are respectively formed in the cam holes 230.

Smooth convex portions 232 over which the cam noses 220 smoothly slide are formed at the center inside the cam holes 230.

Further, seats 233 where the cam noses 220 are seated are formed at the lower portion inside the cam holes 230.

First, as shown in FIG. 5,

when the hinge unit 30 is horizontally positioned, the cam portions 200 of the joint members 100 are also horizontally positioned.

In this case, the cam noses 220 are positioned inside the insertion holes 231 of upper cam portions 200 and the joint members 100 are horizontally in contact with each other without a gap by the tension of the tension members 260 connecting the top fixing grooves 255 and the bottom fixing grooves 256.

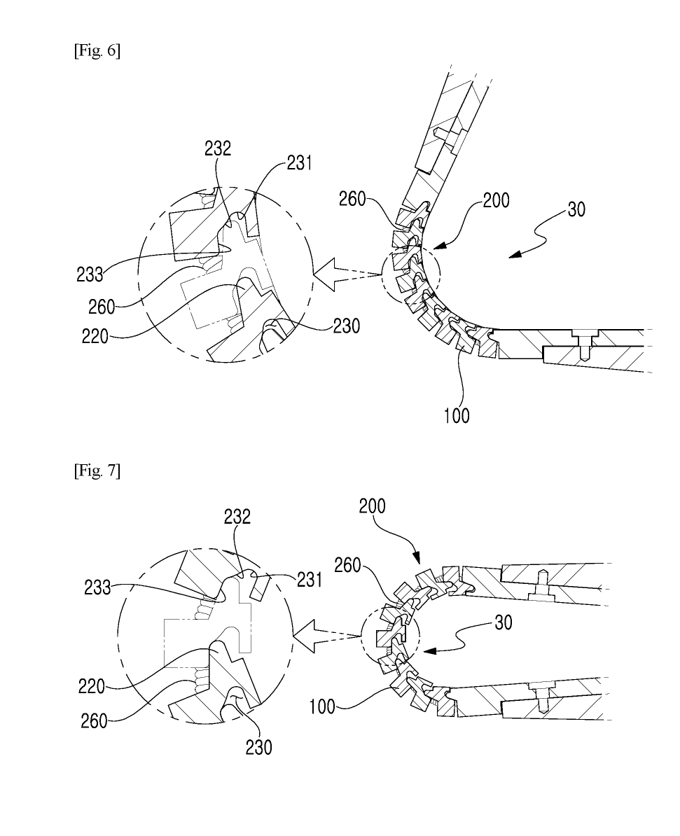

Further, as shown in FIG. 6,

When the hinge unit 30 is bent at about 90 degrees, the cam portions 200 of the joint members 100 are sequentially bent at a predetermined angle by the distributed tension of the tension members 260. In this case, when there are nine joint members 100, the joint members 100 are all bent at about 10 degrees.

In this case, the cam noses 220 smoothly slide over the convex portions 232 at the centers inside the cam holes 230 of the upper cam portion 200.

Accordingly, as the cam noses 220 slide over the convex portions 232, the joint members 100 horizontally positioned in contact with each other are sequentially bent with a predetermined gap therebetween.

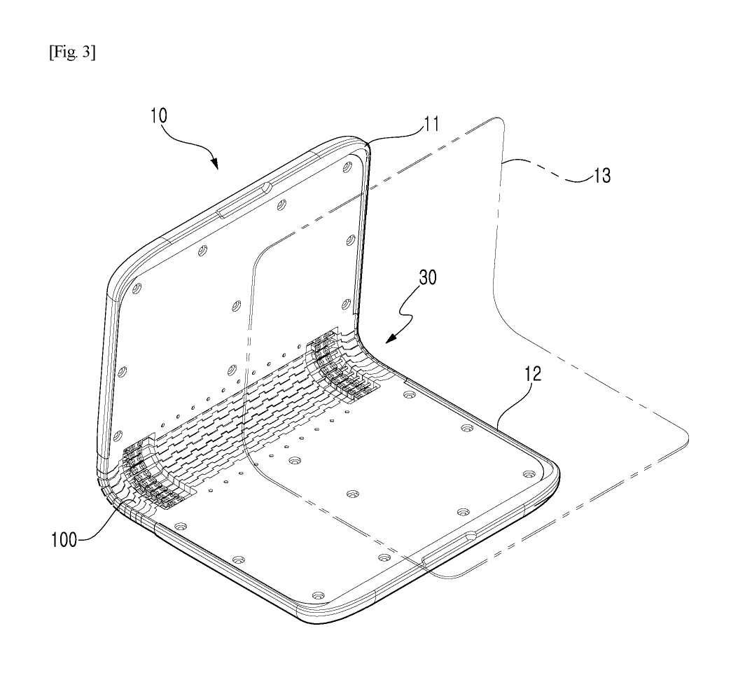

Accordingly, as shown in FIGS. 3 and, 5 to 7,

when the hinge unit 30 is bent in a common flexible display device, an end position difference is generated between the first and second plates 11 and 12 that are at the outside and the flexible display screen 13 that is at the inside, so a variable component (not shown) for guiding the first plate 11 and the second plate 12 that are moved forward/backward is separately mounted to solve the problem of the end position difference.

However, according to the flexible hinge device 10 having a cam structure of the present invention, it is possible to reduce the end position difference between the flexible display device 13 and the first and second plates 11 and 12 only using the hinge unit 30 without an additional variable component due to the structure and operation of the cam noses 220 and the cam holes 230 each having the convex portion 232.

Further, as shown in FIG. 7,

When the hinge unit 30 is fully bent at about 180 degrees, the cam portions 200 of the joint members 100 are sequentially bent at the maximum angle by the distributed tension of the tension members 260. If there are nine joint members 100, the joint members 100 are all bent at about 20 degrees.

In this case, the cam noses 220 are seated on the seats 233 inside the cam holes 230 over the convex portions 232 and the joint members 100 are sequentially bent with the maximum gap therebetween. Accordingly, the hinge unit 30 is bent at the maximum angle.

Further, it may be possible to additionally attach fixing members (not shown) such as magnets or buttons to the ends of the first plate 11 and the second plate 12 in order to keep the flexible hinge device 10 folded with the hinge unit 30 fully bent.

As shown in FIGS. 8 and 9,

fixed portions 300 extending inward from both ends of cam portion 200 with a predetermined distance therebetween are formed at each of the joint members 100.

The fixing members 320 are further coupled to the front sides of the fixed portions 300.

The fixing member 320 has a head 323 and a pin 325 longitudinally extending from an end of the head 323 and the head 323 is coupled to the front side of the fixed portion 300 by fasteners such as bolts or by forcible fitting such that the pin 325 faces the outside.

The pin 325 is fitted in a pierced portion 430 of the pivot portion 400, which will be described below, and rotatably inserted in an oblong hole 452 of a stepped portion 450 of another joint member 100 over the pierced portion 420 and rotation of the pin 325 will be described with the structure of pivot portion 400 to be described below.

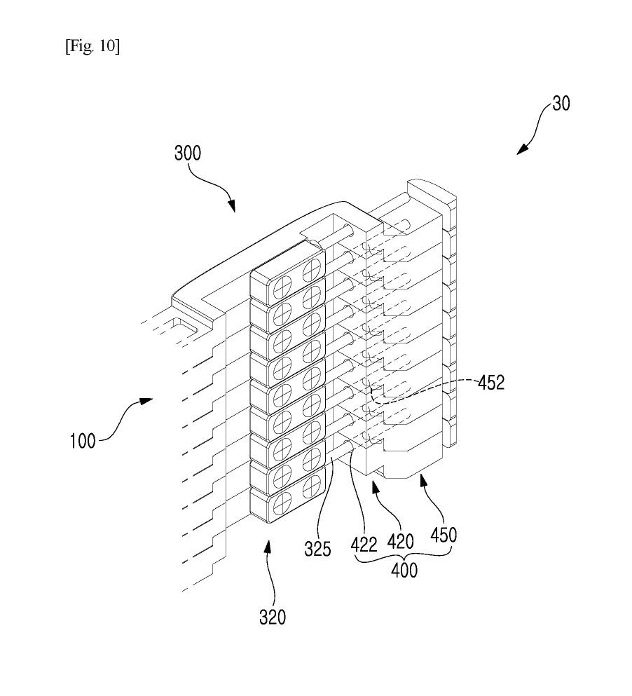

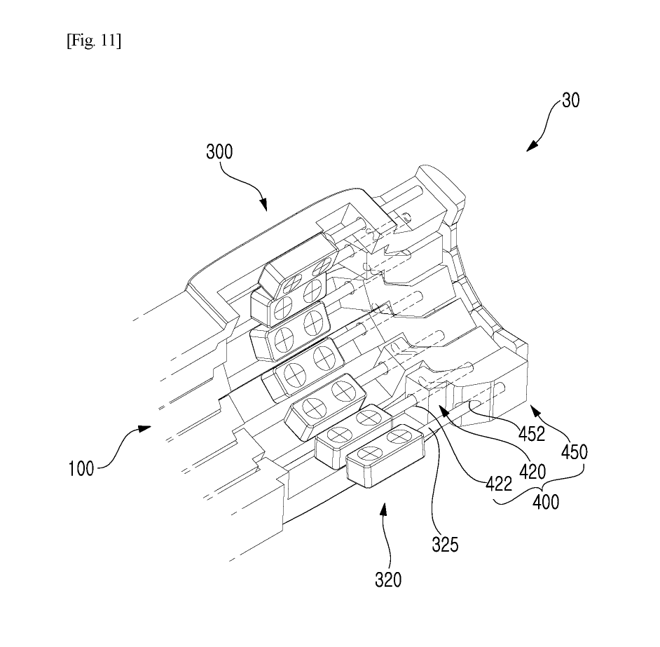

As shown in FIGS. 10 and 11,

the pivot portions 400 extending downward from both ends of the fixed portions 300 are formed at each of the joint members 100.

The pivot portions 400 have the pierced portion 420 having a through-hole 422 therein and the stepped portion 450 formed under the pierced portion 420 and the smooth oblong hole 452 is formed in the stepped portion 450.

The pin 320 of the fixing member 320 coupled to the fixed portion 300 passes through the through-hole 422 of the pierced portion 420 and is rotatably inserted in the oblong hole 452 of the stepped portion 450 of another pivot portion 400 over the pierced portion 420. That is, not only the cam portions 200 are connected by the tension members 250 in the cam portions 200, but the pins 325 are inserted in the oblong holes 452 of upper pivot portions 400, whereby the joint members 100 are doubly connected.

As shown in FIGS. 10 and 11,

First, when the hinge unit 30 of the hinge device 10 according to an embodiment of the present invention is horizontally positioned, the pivot portions 400 of the joint members 100 are all also horizontally positioned by the tension of the tension members 260. In this case, the pins 325 are positioned at the upper portions inside the oblong holes 452 of upper pivot portions 400.

When the hinge unit 30 is bent at about 90 degrees, the pins 325 are positioned at the middle portions inside the oblong holes 452, and when the hinge unit 30 is further bent at about 180 degrees, the pins 325 are positioned at the lower portions inside the oblong holes 452.

That is, as the hinge unit 30 is bent, the pins 325 smoothly move downward inside the oblong holes 452 of upper pivot portions 400.

The point of the operation of the entire flexible hinge device having a cam structure according to an embodiment of the present invention is described hereafter.

As shown in FIGS. 5 and 10, when the hinge unit 30 is horizontally positioned, the joint members 100 are pulled horizontally in contact with each other without a gap by the tension of the tension members 260 and the pins 325 are positioned at the upper portions inside the oblong holes 452 of upper pivot portions 400.

As shown in FIGS. 6 and 11, when the hinge unit 30 is bent at a predetermined angle, the joint members 100 are all bent at the same angle by the distributed tension of the tension members 260, the cam noses 220 slide over the convex portions 232 at the center portions inside the cam holes 230, and the joint members 100 are bent with a predetermined gap therebetween. In this case, the pins 325 are positioned at the center portions inside the oblong holes 452.

As shown in FIGS. 7 and 11, when the hinge unit 30 is bent at the maximum angle, the cam noses 220 are seated on the seats 233 formed at the lower portions inside the cam holes 230 and the joint members 100 are bent with the maximum gap therebetween. In this case, the pins 325 are positioned at the lower portions inside the oblong holes 452.

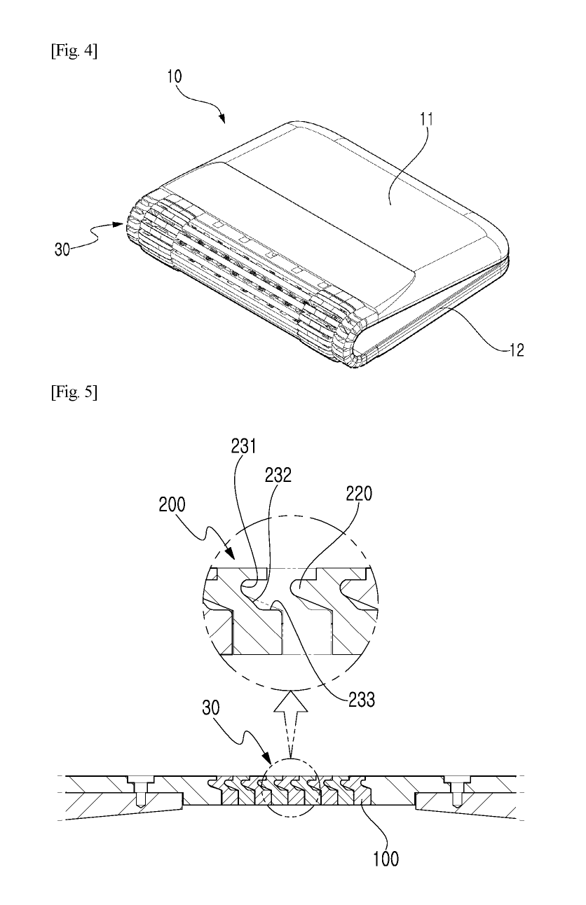

Further, in order to keep the hinge unit 30 bent, it is possible to additionally attach fixing members (not shown) such as magnets or buttons to the ends of the first plate 11 and the second plate 12, which was described above (see FIG. 4).

The above description is just an example for explaining the flexible hinge device having a cam structure according to the present invention. It should be understood that the present invention is not limited to the embodiment and may be modified in various ways by those skilled in the art without departing from the scope described in the following claims, and such modifications are included in the scope of the present invention.

### INDUSTRIAL APPLICABILITY

According to the flexible hinge device having a cam structure of the present invention, it is possible to reduce the end position difference between first and second plates, and a flexible display screen by using only a hinge unit without an additional variable component. Further, it is possible to bend all of the joint members of the hinge unit through the distributed tension of a plurality of tension members.

1. A flexible hinge device having a cam structure, the device comprising:
a first plate and a second plate equipped with a foldable flexible display screen on tops thereof; and
a hinge unit connecting the first plate and the second plate to each other and being able to bend and unbend,
wherein the hinge unit is composed of a plurality of joint members that are connected to each other to bend or unbend, and the first plate and the second plate are respectively connected to outermost joint members of the joint members, and
the joint members each have:
a cam portion longitudinally extending;
fixed portions extending inward at both ends of the cam portion with a predetermined gap therebetween;
fixing members each having a head and a pin longitudinally extending at an end of the head; and
pivot portions extending outward at both ends of the fixed portions with a predetermined gap therebetween.

2. The device of claim 1, wherein the cam portion has:
a plurality of cam noses protruding from a top of the cam portion and arranged in series with a predetermine distance therebetween; and
a plurality of cam holes formed on a bottom of the cam portion to vertically correspond to the cam noses.

3. The device of claim 2, wherein the cam holes each have:
an insertion hole formed at an upper portion inside the cam hole so that a cam nose of a lower cam portion is inserted therein;
a convex portion formed at a center portion inside the cam hole such that the cam nose smoothly slides over the convex portion; and
a seat formed at a lower portion inside the cam hole to seat the cam nose thereon.

4. The device of claim 2, wherein the cam portions each have:
a plurality of top fixing grooves formed between the cam noses;
a plurality of bottom fixing grooves famed between the cam holes; and
tension members connecting the top fixing grooves and the bottom fixing grooves of a cam portion adjacent to the top fixing grooves to each other.

5. The device of claim 4, wherein the tension members connect even-numbered or odd-numbered top fixing grooves and the bottom fixing grooves of a cam portion adjacent to the top fixing grooves to each other.

6. The device of claim 4, wherein the tension members are coil springs or spiral springs.

7. The device of claim 5, wherein cover plates or magnets are attached to other top fixing grooves and bottom fixing grooves except for the top fixing grooves or the bottom fixing grooves connected by the tension members.

8. The device of claim 1, wherein the heads are coupled to front sides of the fixed portions such that the pins face the outside.

9. The device of claim 1, wherein the pivot portions each have:
a pierced portion having a through-hole therein; and
a stepped portion formed under the pierced portion, and
a smooth oblong hole is formed in the stepped portions.

10. The device of claim 9, wherein the pins pass through the through-holes and are rotatably inserted in the oblong holes of stepped portions over the pierced portions.
